(19) United States
(12) Patent Application Publication
(10) Pub. No.: US 2021/0405568 A1
(43) Pub. Date: Dec. 30, 2021

(54) Operation Status Prediction System, Defect Occurrence Prediction System, Image Forming System, and Operation Status Prediction Method

(71) Applicant: Konica Minolta, Inc., Tokyo (JP)

(72) Inventors: Keiki KATSUMATA, Tokyo (JP); Kazutoshi KOBAYASHI, Toyokawa-shi (JP); Tomohiro KAWASAKI, Sagamihara-shi (JP); Kei OKAMURA, Yokohama-shi (JP)

(73) Assignee: Konica Minolta, Inc., Tokyo (JP)

(21) Appl. No.: 17/351,577

(22) Filed: Jun. 18, 2021

(30) Foreign Application Priority Data
Jun. 30, 2020 (JP) 2020-113042

(51) Int. Cl. G03G 15/00; G06F 11/07

(52) U.S. Cl. CPC G03G 15/55; G03G 15/0856; G06F 11/0733

(57) ABSTRACT

An operation status prediction system includes a hardware processor. The hardware processor acquires data, which is relevant to an operation status at each timing of an operation device to be monitored, so as to be associated with information of the timing. The hardware processor predicts a future operation status according to the acquired operation status for each of a plurality of periods having different lengths from the present.

### CROSS-REFERENCE TO RELATED APPLICATIONS

The entire disclosure of Japanese Patent Application No. 2020-113042 filed on Jun. 30, 2020 is incorporated herein by reference in its entirety.

### BACKGROUND

### Technological Field

The present invention relates to an operation status prediction system, a defect occurrence prediction system, an image forming system, and an operation status prediction method.

### Description of the Related Art

In an operation device that performs various operations, various problems occur due to accumulation of changes (mainly deterioration) over time due to operations. The occurrence of such problems depends not only on the simple amount of operation or operation time but also on the operating environment, such as ambient temperature or humidity. JP 2015-174256 A discloses a technique in which, in an image forming apparatus, a machine learning model is trained based on learning data, which is obtained by inputting the status of use in a period during which a sign is obtained before the date of occurrence of a failure as a reference, and the number of days until the occurrence of the failure is predicted based on the current status of use.

### SUMMARY

However, there may be a problem if a defect that is predicted to occur occurs as expected. To cope with this, the defect occurrence timing can be adjusted to some extent by changing the operation status. However, some operation statuses may be difficult to change immediately, or even if the operation statuses are changed, the magnitude or immediate effect of the influence on the defect occurrence timing may be different. Accordingly, there is a problem in the related art that it is not possible to flexibly and effectively take measures after prediction.

It is an object of the invention to provide an operation status prediction system, a defect occurrence prediction system, an image forming system, and an operation status prediction method capable of obtaining an operation status prediction result allowing more effective measures according to a situation.

To achieve at least one of the abovementioned objects, according to an aspect of the present invention, an operation status prediction system, reflecting one aspect of the present invention includes, a hardware processor, wherein, the hardware processor acquires data, which is relevant to an operation status at each timing of an operation device to be monitored, so as to be associated with information of the timing, and the hardware processor predicts a future operation status according to the acquired operation status for each of a plurality of periods having different lengths from the present.

According to another aspect, a defect occurrence prediction system includes the operation status prediction system; and a third storage that stores a first correspondence relationship between the operation status and occurrence of a predetermined defect in the operation device, wherein, the hardware processor calculates a predetermined index relevant to a possibility of occurrence of the defect based on the predicted operation status and the first correspondence relationship.

According to another aspect, an image forming system includes the defect occurrence prediction system.

According to another aspect, an operation status prediction method includes status acquiring in which data relevant to an operation status of an operation device to be monitored at each timing is acquired so as to be associated with information of the timing; and status predicting in which a future operation status is predicted according to the operation status acquired in the status acquiring for each of a plurality of periods having different lengths from the present.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is a block diagram showing the functional configuration of an image forming apparatus;

FIG. 2 is a diagram describing the flow of an abnormality occurrence prediction operation in the image forming apparatus;

FIGS. 3A and 3B are charts showing an example of operation parameter contribution data;

FIG. 4 is a flowchart showing the control procedure of a defect occurrence prediction process;

FIG. 5 is a flowchart showing the control procedure of a prediction model update process;

FIG. 6 is a flowchart showing the control procedure of a short-term suppression control process relevant to the occurrence of a toner spill defect; and

FIG. 7 is a flowchart showing the control procedure of a long-term suppression control process relevant to the occurrence of a toner spill defect.

### DETAILED DESCRIPTION OF THE EMBODIMENTS

Hereinafter, one or more embodiments of the present invention will be described with reference to the drawings. However, the scope of the invention is not limited to the disclosed embodiments.

Hereinafter, an embodiment of the invention will be described with reference to the accompanying diagrams.

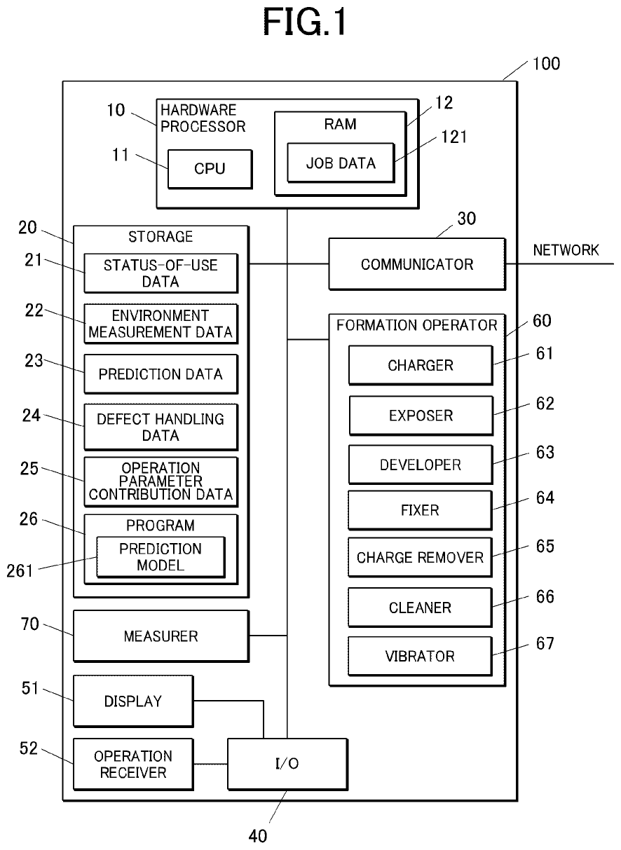

FIG. 1 is a block diagram showing the functional configuration of an image forming apparatus 1, which is an image forming system of the present embodiment and includes an operation status prediction system and a defect occurrence prediction system.

The image forming apparatus 1 includes a hardware processor 10, a storage 20 (a first storage, a second storage, a third storage, and a fourth storage), a communicator 30, and an interface (I/O) 40, a formation operator 60 (operation device to be monitored), and a measurer 70. A display 51, an operation receiver 52, and the like are connected to the interface 40.

The hardware processor 10 comprehensively controls the overall operation of the image forming apparatus 1. The hardware processor 10 includes a central processing unit (CPU) 11, a random access memory (RAM) 12, and the like.

The CPU 11 is a hardware processor that performs arithmetic processing relevant to various control operations and the like. The RAM 12 provides a working memory space for the CPU 11, and stores temporary data and the like. The data stored in the RAM 12 includes image data relevant to the image forming command and job data including operation setting data. The RAM that stores the job data or its processing data may have a dedicated area set separately from the other RAMs.

The storage 20 stores various programs or setting data. The storage includes a non-volatile memory, such as a flash memory, and/or a hard disk drive (HDD). Some storages 20 may be volatile memories. The storage 20 stores status-of-use data 21, environment measurement data 22, prediction data 23, defect handling data 24, operation parameter contribution data 25, a program 26, and the like.

The status-of-use data 21 includes data of the operation status of the formation operator 60 of the image forming apparatus 1 obtained based on job data 121 acquired by the image forming apparatus 1, for example, the image size, the type of medium on which images are formed, the cumulative number of sheets on which images are formed, the distribution of the image formation range, the distribution of toner density, and the distribution of the amount of operation per time (the number of sheets on which images are formed and the like). A plurality of unit times may be set for the amount of operation per time. For example, the unit times may include some or all of one hour, one day, each day of the week, one week, and one month.

The environment measurement data 22 stores the internal and external environmental states of the image forming apparatus 1 measured by the measurer 70. The status-of-use data 21 and the environment measurement data 22 configure data relevant to the operation status of the present embodiment, and correspond to the stored content of the first storage.

The prediction data 23 stores prediction data of the status of use or the environmental state predicted in advance as described later. As for the status-of-use data 21, the environment measurement data 22, and the prediction data 23, old and unnecessary data may be deleted. In this case, the memory of the storage 20 is released and reused at an appropriate cycle. The prediction data 23 corresponds to the stored content of the second storage of the present embodiment.

The defect handling data 24 is quantitative data according to the relationship set between the environment and a defect that occurs in the image forming apparatus 1 in advance based on past cases or experiments. The operation parameter contribution data 25 is data indicating the degree of contribution of the operation parameter to a defect that occurs in the image forming apparatus 1 in advance based on past cases or experiments. The program 26 includes a prediction model 261. The defect handling data 24, the operation parameter contribution data 25, and the program 26 will be described later.

The communicator 30 controls data communication with an external apparatus. The communicator 30 has, for example, a network card, and controls communication with an external electronic apparatus connected by a local area network (LAN), for example, a personal computer (PC) operating as a print server.

The interface 40 includes a connection terminal or a driver for connection to peripheral devices. As described above, the display 51 and the operation receiver 52 are connected to the interface 40.

The display 51 has, for example, a display screen, and displays various kinds of information, for example, an image formation status or a menu relevant to the setting received from the user, based on the control of the hardware processor 10. The operation receiver 52 has, for example, a touch panel located so as to overlap the display screen, detects a touch operation from the outside, such as a user, and outputs the detected touch operation to the hardware processor 10 as an input signal. The display 51 has, for example, a liquid crystal display screen, and may have light emitting diode (LED) lamps of respective colors and the like without being limited to the liquid crystal display screen. The operation receiver 52 may have a numeric keypad, a keyboard, a pointing device (a mouse or the like), a push button switch, a rocker switch, and the like in addition to or instead of the touch panel.

The formation operator 60 performs an operation of supplying a predetermined medium and forming an image designated by the job data 121 on the surface of the medium. The formation operator 60 performs an image forming operation by applying and fixing four color toners of cyan (C), magenta (M), yellow (Y), and black (K) onto the medium using an electrophotographic method. The formation operator 60 includes a charger 61, an exposer 62, a developer 63, a fixer 64, a charge remover 65, a cleaner 66, a vibrator 67, and the like.

The charger 61 charges a photoconductor drum. The exposer 62 emits laser light to the surface of the photoconductor drum to form a latent image according to the image data to be formed. The developer 63 supplies a toner mixed with a developer by a developing roller (developing sleeve) to the surface of the photoconductor drum on which the latent image is formed by the exposer 62, so that the toner according to the latent image adheres to the surface of the photoconductor drum. The toner adhering to the photoconductor drum is transferred onto the medium. The fixer 64 fixes the toner onto the medium to form an image. The charge remover 65 removes the electric charge of the toner particles (including the developer) remaining on the photoconductor drum after transfer. The cleaner 66 removes the toner particles remaining on the photoconductor drum with a brush, a blade, or the like, and applies a lubricant to the surface of the photoconductor drum after removal.

The vibrator 67 causes vibration in the housing in which each component of the formation operator 60, in particular, the developer 63 is housed. The vibrator 67 has, for example, a motor that rotates a weight or the like, and causes vibration in the housing by colliding with the housing at each rotation cycle of the weight to hit the housing. By the operation of the vibrator 67, the toner adhering to the inside of the housing is dropped. The strength of vibration by the vibrator 67 can be set in a plurality of stages within a range in which there is no adverse effect on the image formation accuracy of the image forming apparatus 1. In the initial state, the vibration strength may be set to be weak to the minimum. A suction port of a sucker for sucking the falling toner may be located in the housing. The vibrator 67 is included in a suppression operator that suppresses the occurrence of at least a defect relevant to toner spill in the image forming system of the present embodiment.

The measurer 70 measures the internal and external environmental states of the image forming apparatus 1. Examples of the environmental state include temperature and humidity. The measurement data of the environmental state is transmitted to the hardware processor 10 at a predetermined cycle, for example, a 1-minute cycle, and is stored in the environment measurement data 22 of the storage 20. Not only individual values, such as temperature and humidity, but also the amount of change, the rate of change, and the like may be included in the environmental state. As the humidity, in addition to the relative humidity that is normally used, absolute humidity may be used.

In addition, the image forming apparatus 1 (image forming system) may include various post-processing devices that perform post-processing, for example, cutting on the medium on which images are formed. A monitoring device that comprehensively monitors the operation status of each unit when operating as an image forming system may be separately provided.

Next, the malfunction of the image forming apparatus 1 will be described.

In the image forming apparatus 1, each part, consumables, fixed assembly parts, and the like deteriorate particularly due to continuous use of the formation operator 60 for a long period of time. If such deterioration exceeds a reference level, the image quality of the formed image may be adversely affected, and accordingly, defects (noise) such as stains, bleeding, blurring, and loss of the image may occur. The reference level at which the adverse effect on the image due to such deterioration appears differs depending on the content of the image. For example, a defect may appear earlier than the average deterioration condition depending on the bias of each toner, the density or size of the formed image, the change in density or image formation range between the previous image and the next image, and the like. On the contrary, there are cases where the effect is hard to appear. The effect of deterioration may become stronger or weaker depending on the environmental state, that is, the change in the state of each unit according to the temperature or humidity, for example, the hardness of the blade of the cleaner 66 (for example, the hardness of the resin changes depending on the temperature) or the change in temperature of fixing by the fixer 64.

The operation of the image forming apparatus 1 has some variable parameters. For example, the maximum image density Dmax or the like can be changed by adjusting the amount of charge (Q/M) of the toner, the ratio of the rotation speed of the developing roller (developing sleeve) to the rotation speed of the photoconductor drum (development θ), the toner density Tc, and the like. Depending on the situation, the operation frequency of the vibrator 67, the contact angle of the blade of the cleaner 66, the amount of lubricant applied, and the like can be changed. Although not particularly limited, the development θ can be set in two ways, large and small. When the development θ is set to be large, a flag indicating the fact (development θ flag) is set. When the development θ is set to be small, the development θ flag is reset.

Therefore, whether or not an image defect (abnormal image quality of the formed image) occurs is determined by the combination of not only the cumulative status of use but also the influence of the latest operation, the environmental state (referred to collectively as an operation status), or the like, the setting of operation parameters, and the like. In order to predict the occurrence of abnormalities in the image in advance, the future operation status is predicted, and then the influence of the current operation parameters is added.

In the image forming apparatus 1, a prediction model 261 is used to predict the operation status. The prediction model 261 is a model (machine learning model) that can be mechanically trained (as teacher data) based on prediction data and actual data relevant to the past operation status. The algorithm of the prediction model 261 is not particularly limited, and an algorithm suitable for the output content may be used. For example, a machine learning model trained by deep learning using a neural network or the like may be used for the learning and prediction of the status of use. An autoregressive integrated moving average (ARIMA) model or the like may be used for the learning and prediction of the operating environment such as temperature or humidity. A sequentially discounting autoregressive algorithm (SDAR) may be used to extract change points relevant to the operating environment. As a result, the same output variable as the input variable for each period may be obtained as a predicted value, or time-series data may be output. Alternatively, something like the distribution of the probability of occurrence in the corresponding period of each variable relevant to the operation status may be output.

The operation status including the environmental state is associated in advance with an index value (defect occurrence index; a predetermined index relevant to the possibility of defect occurrence) indicating the likelihood of occurrence of an abnormality (defect) by a correspondence table or conversion expression (first correspondence relationship) as the defect handling data 24. The combination of operation status elements associated with a plurality of abnormality types (predetermined defects) may be different. The defect handling data 24 corresponds to the content stored in the third storage of the present embodiment.

Each operation parameter (operation setting) is associated with a score indicating the contribution to the occurrence of an abnormality based on the operation parameter contribution data 25, and the total value of the scores relevant to the respective operation parameters is converted into the degree of contribution (contribution coefficient) to the defect occurrence index (these are referred to collectively as the second correspondence relationship). The final likelihood of occurrence of a defect is obtained by multiplying the obtained defect occurrence index by the degree of contribution. The defect occurrence index may be a direct value, such as the probability of occurrence of an abnormality, or may be a unique index value. The operation parameter contribution data 25 corresponds to the content stored in the fourth embodiment of the present embodiment.

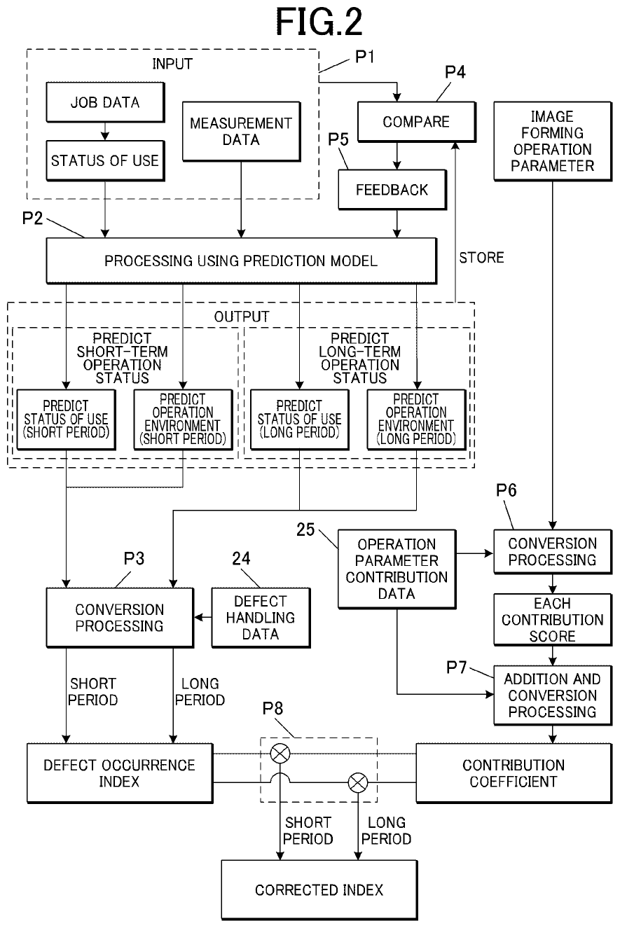

FIG. 2 is a diagram describing the flow of an abnormality occurrence prediction operation in the image forming apparatus 1.

First, job data and measurement data are acquired as input data, and status-of-use data is acquired from the job data (P1). As for the cumulative data (for example, the cumulative number of sheets on which images are formed), the history data may be directly acquired from the image forming apparatus 1, or the hardware processor 10 may count and hold the data. The job data may include a cancellation log when the image forming operation is stopped on the way, and the like. The operation status (status-of-use data and measurement data) is input to the prediction model 261, and the future operation status prediction is output from the prediction model 261 (P2).

The prediction model 261 outputs operation status predictions in two different types of periods, which are a short period and a long period. The short-term prediction is, for example, to predict the status of use and the operating environment in a period of about several hours to one day from the time when the data is input. The long-term prediction is, for example, to predict the status of use and the operating environment in a period of about two days to one month from the time when the data is input.

From the prediction data of the status of use and the operating environment, the defect occurrence index is calculated based on the defect handling data 24 (P3). The defect occurrence index is also calculated separately for the short-term prediction and the long-term prediction.

On the other hand, the pieces of prediction data of the status of use and the operating environment are stored, and are read out and compared at the stage when the status of use and the operating environment in the prediction target period are acquired and measured (P4). The comparison result is fed back to each parameter of the machine learning model (P5).

The current operation parameters relevant to the image forming operation are acquired, and converted into scores relevant to the contribution to the occurrence of defects by the operation parameter contribution data 25 (P6). The respective scores are added up, and the total value is further converted into a contribution coefficient (P7).

Corrected defect occurrence indices are calculated by multiplying the defect occurrence indices for the long and short periods by the contribution coefficient (P8).

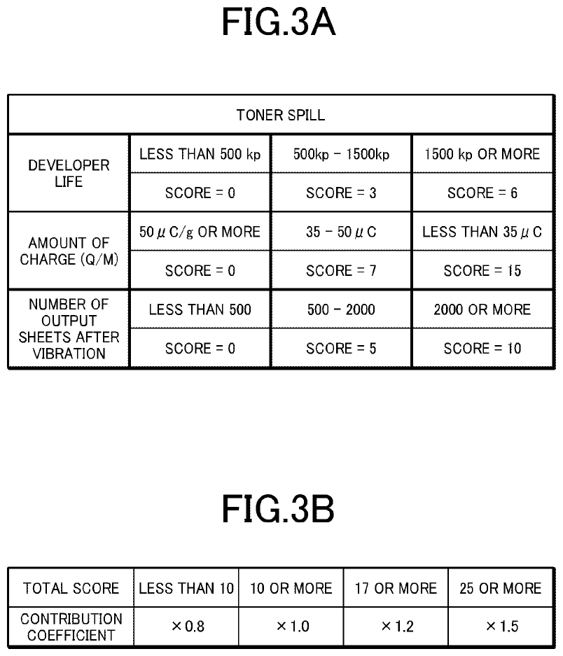

FIGS. 3A and 3B are charts showing an example of the operation parameter contribution data 25. The score setting of the operation parameters relevant to the occurrence of toner spill, which is one of the causes of stains on the medium, and the relationship between the total value of scores (total score) and the contribution coefficient are shown. The “toner spill” herein refers to all states in which unintended toner adheres to the medium. For example, not only a case where the toner spills directly from the developer 63 onto the medium but also a case where toner particles scattered during development or cleaning adhere to each unit to indirectly stain the medium may be included.

As shown in FIG. 3A, operation parameters relevant to the toner spill are the developer life, that is, the number of sheets on which images are formed from the start of the use of the current developer, the amount of charge (Q/M) of the toner, and the number of output sheets after the latest vibration by the vibrator 67.

The developer is mixed with the toner so that the toner has an appropriate amount of charge and voltage. The developer adheres to the developing roller to carry the toner, and then further transfers the toner onto the photoconductor drum according to the exposure state of the surface of the photoconductor drum. Since the developer deteriorates after long-term use, it becomes difficult to properly carry the toner onto the surface of the photoconductor drum. For example, when the developer life is less than 500 kp (500,000 sheets), the score is “0”. In the case of 500 kp to 1500 kp (hereinafter, “to” indicates equal to or greater than the former number and less than the latter number), the score is “3”. When the developer life is 1500 kp or more, the score is “6”.

Similarly, when the amount of charge is 50 μC/g or more, the score is “0”. When the amount of charge is 35 to 50 μC/g, the score is “7”. When the amount of charge is less than 35 μC/g, the score is “15”. When the number of output sheets after the latest vibration by the vibrator 67 is less than 500, the score is “0”. When the number of output sheets is 500 to 2000, the score is “5”. When the number of output sheets is 2000 or more, the score is “10”.

The scores are divided into three stages, but the invention is not limited thereto. The scores may be continuously determined by a mathematical expression without being determined in stages. The scores of the three stages are different, that is, the scores of the operation parameters that have a relatively large effect on toner spill can be higher than the scores of the other operation parameters.

When three scores are obtained according to the three operation parameters, the three scores are added up to obtain a total score. As shown in FIG. 3B, the total score is divided into four stages, and the contribution coefficient is determined according to the corresponding total score. The contribution coefficient is multiplied by the separately obtained defect occurrence index to calculate a corrected defect occurrence index.

When the total score is less than 10, the contribution coefficient is 0.8, that is, smaller than 1.0. Therefore, it can be seen that the operation parameters are located on the side that suppresses the occurrence of defects as a whole. On the other hand, when the total score is 17 or more, the contribution coefficient is larger than 1.0. Therefore, it can be seen that the operation parameters are located on the side that promotes the occurrence of defects as a whole.

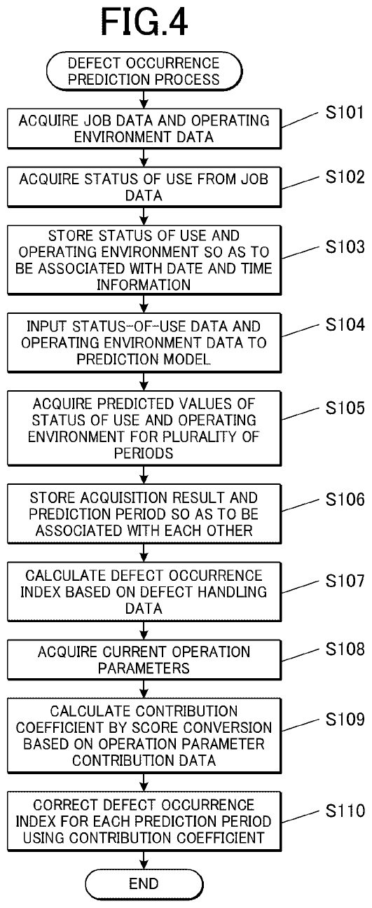

FIG. 4 is a flowchart showing the procedure of control by the hardware processor 10 in a defect occurrence prediction process performed by the image forming apparatus 1.

This defect occurrence prediction process includes an operation status prediction method (defect occurrence prediction method) of the present embodiment, and is started periodically at intervals of about the short-term prediction period of the status of use and the operating environment to about a half thereof or based on the user's input operation at the start of or during the operation of the image forming apparatus 1 although not particularly limited.

The hardware processor 10 (CPU 11) acquires job data in an appropriate period and operating environment data (step S101). The hardware processor 10 acquires the status of use based on the job data (step S102). The appropriate period for acquiring the status of use from the job data is the latest predetermined time or the like. However, for example, when the image forming apparatus 1 is started, the appropriate period may be a period of a predetermined time from the timing when the supply of power to the image forming apparatus 1 was cut off most recently. As described above, the status of use is, for example, the average number of sheets on which images are formed (print volume, A4 size conversion, and the like). The number of sheets on which images are formed per job, the average density of each color toner applied in each area, the size (coverage) of a margin or a gap, the rate of change thereof, and the like can be mentioned. As described above, the average may be calculated for each job and for a plurality of unit times, and a plurality of average target periods may be set within the predetermined time. The status of use may include the type of medium (size, paper type, basis weight, and the like) or the like. When the image forming apparatus 1 has a post-processing device, a separate monitoring device, or the like, the status relevant to the use of the post-processing device or the monitoring device may also be included.

The operating environment data may include, for example, the temperature and humidity in the housing of the image forming apparatus 1 for the predetermined period and the external temperature and the external humidity at a predetermined position outside the image forming apparatus 1. Each piece of the acquired data is associated with timing information. The processing of steps S101 and S102 (corresponding to P1 in FIG. 2) configures a status acquirer and a status acquisition step of the present embodiment. In this manner, data relevant to the operation status at each timing input to the prediction model 261 is obtained.

The hardware processor 10 stores the obtained status-of-use data in the storage 20 as the status-of-use data 21. The hardware processor 10 stores the obtained operating environment data in the storage 20 as the environment measurement data 22 (step S103).

The hardware processor 10 causes the obtained operation status data to be input to the prediction model 261 (step S104). The hardware processor 10 acquires each predicted value of the future operation status output from the prediction model 261 (step S105). As described above, the predicted values acquired at this time are two types (a plurality of periods having different lengths), one for a short period and the other for a long period. The processing of steps S104 and S105 (corresponding to P2 in FIG. 2) configures a status predictor and a status prediction step of the present embodiment.

The hardware processor 10 stores each acquired prediction result in the storage 20 as the prediction data 23 so as to be associated with the date and time information of the prediction period (step S106). Based on the defect handling data 24, the hardware processor 10 calculates an index relevant to the likelihood of occurrence (probability of occurrence) of a defect according to the acquired prediction of the status of use and the acquired prediction of the operating environment, as a defect occurrence index, for each of a long period and a short period (for a plurality of different periods)(step S107; defect predictor. Corresponds to P3 in FIG. 2).

The hardware processor 10 acquires the current operation parameters (step S108; setting acquirer). The hardware processor 10 acquires scores corresponding to each operation parameter based on the operation parameter contribution data 25, and adds up the scores. The hardware processor 10 converts the total score value into a contribution coefficient with reference to the operation parameter contribution data 25 (step S109; corresponding to P6 and P7 in FIG. 2). The hardware processor 10 corrects the defect occurrence index by multiplying the defect occurrence index by the contribution coefficient (step S110; corresponding to P8 in FIG. 2). The processing of steps S109 and S110 may also be included in the configuration of the defect predictor of the present embodiment. Then, the hardware processor 10 ends the defect occurrence prediction process.

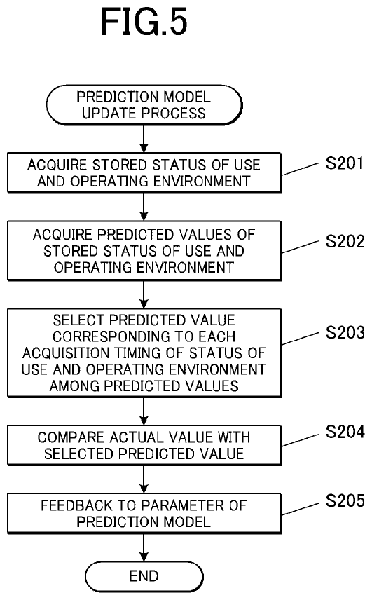

FIG. 5 is a flowchart showing the procedure of control by the hardware processor 10 in a prediction model update process. The execution frequency of the prediction model update process may be equal to or less than the execution frequency of the defect occurrence prediction process, and the execution timings may be different from each other. For example, the prediction model update process may be performed before the supply of power is cut off after the end of the image forming operation of the day.

Once the prediction model update process starts, the hardware processor 10 (CPU) acquires the actual values of the status of use and the operating environment stored in the storage 20 from the status-of-use data 21 and the environment measurement data 22, respectively (step S201). The hardware processor 10 acquires the stored predicted values of the status of use and the operating environment from the prediction data 23 (step S202). The hardware processor 10 selects a predicted value corresponding to the acquisition timing of the actual value among the predicted values (step S203).

The hardware processor 10 compares the actual value (actual operation status) with the associated predicted value (predicted operation status) (step S204; comparer. Corresponds to P4 in FIG. 2). The hardware processor 10 acquires the degree of deviation (degree of matching) as a comparison result. The degree of deviation may not be determined uniformly, and may be considered to reduce (in irregular cases) and/or emphasize (in cases of actual discontinuous changes) the influences of specific changes. The hardware processor 10 feeds the comparison result back to each parameter of the prediction model 261 (for learning) according to the obtained degree of deviation, and updates the prediction model 261 (step S205; updater. Corresponds to P5 in FIG. 2. Also corresponds to a generator). Then, the hardware processor 10 ends the prediction model update process.

The prediction model update process may be performed not only at the time of update but also at the time of initial learning. That is, the same process may be performed even at the time of generation of the prediction model. In this case, input data (teacher data) needs to be prepared in advance for initial learning. If there is a change in the operating environment due to seasonal changes, it may take one year to learn from the measurement data of its own machine alone. Therefore, for example, effective initial learning may be possible by holding general common data in advance or making the general common data available through a network.

As described above, when the information on the likelihood of occurrence of a defect is obtained, the user takes action according to the information. For example, in addition to arranging for replacement parts or substitutes and adjusting the schedule for image forming work (for example, adjusting the order of jobs in the short term and planning downtime due to maintenance in the long term), even in the image forming apparatus 1, the operation may be adjusted under the operating conditions according to the defect occurrence index so that a grace period until an actual defect occurs is obtained. In this case, there are an adjustment to prevent the occurrence of defects immediately although this is an ad hoc measure and an adjustment to prolong the occurrence of defects in the long term. The former adjustment is made according to the defect occurrence index for the short term, and the latter adjustment is made according to the defect occurrence index for the long term.

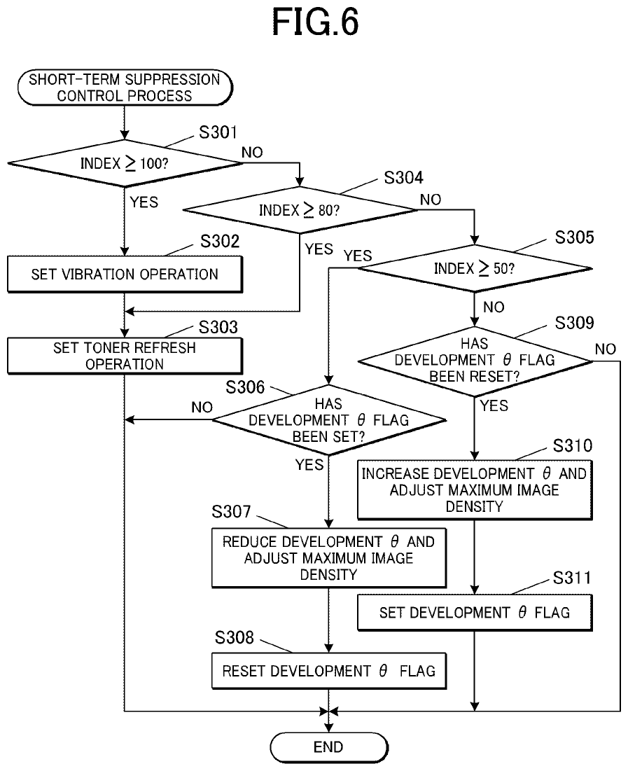

FIG. 6 is a flowchart showing the procedure of control by the hardware processor 10 in a short-term suppression control process performed according to the short-term prediction result relevant to the occurrence of a toner spill defect. This short-term suppression control process may be performed subsequently when the result of the above defect occurrence prediction process is acquired.

Once the short-term suppression control process starts, the hardware processor 10 (CPU 11) determines whether or not the obtained defect occurrence index is 100 or more (step S301). When it is determined that the defect occurrence index is 100 or more (“YES” in step S301), the hardware processor 10 (CPU 11) sets a vibration operation to be performed the vibrator 67 (step S302). The vibration operation is not performed during the image forming operation. Therefore, when image formation is not performed, the vibration operation is immediately performed. During the image forming operation, the vibration operation is performed after the current image forming operation ends.

The hardware processor 10 sets a toner refresh operation (step S303). When the toner supplied from a supplier, such as a toner cartridge, is held in the developer 63 for a long time without being used, deterioration occurs. For this reason, the toner refresh operation is to promote the replacement of the toner by forming a latent image for discharge, which is not used for actual image formation, on the photoconductor drum and discharging the toner by developing the latent image for discharge. The discharged toner is removed by the cleaner 66 without being transferred onto a medium or the like. Then, the hardware processor 10 ends the short-term suppression control process.

When it is determined in the determination process of step S301 that the defect occurrence index is not 100 or more (is less than 100) (“NO” in step S301), the hardware processor 10 determines whether or not the defect occurrence index is 80 or more (step S304). When it is determined that the defect occurrence index is 80 or more (“YES” in step S304), the process of the hardware processor 10 proceeds to step S303.

When it is determined that the defect occurrence index is not 80 or more (is less than 80) (“NO” in step S304), the hardware processor 10 determines whether or not the defect occurrence index is 50 or more (step S305). When it is determined that the defect occurrence index is 50 or more (“YES” in step S305), the hardware processor 10 determines whether or not the development θ flag is set, that is, whether or not the development θ is set high (step S306). When it is determined that the development θ flag is set (“YES” in step S306), the hardware processor 10 reduces the development θ. Then, the hardware processor 10 adjusts the maximum image density Dmax (step S307). The hardware processor 10 resets the development θ flag (step S308). Then, the hardware processor 10 ends the short-term suppression control process.

When it is determined that the development θ flag is not set (“NO” in step S306), the hardware processor 10 ends the short-term suppression control process.

When it is determined in the determination process of step S305 that the defect occurrence index is not 50 or more (“NO” in step S305), the hardware processor 10 determines whether or not the development θ flag is in the reset state (step S309). When it is determined that the development θ flag is in the reset state (“YES” in step S309), the hardware processor 10 increases the development θ. Then, the hardware processor 10 adjusts the maximum image density Dmax (step S310). The hardware processor 10 sets the development θ flag (step S311). Then, the hardware processor 10 ends the short-term suppression control process. When it is determined that the development θ flag is not in the reset state (is set) (“NO” in step S309), the hardware processor 10 ends the short-term suppression control process.

Thus, when the defect occurrence index is high, the factors leading to toner spill at the present time can be promptly reduced by immediately executing the vibration operation or the toner refresh operation. If the defect occurrence index increases to the approximately medium level, the development θ is decreased to reduce toner scattering, thereby reducing toner spill trigger elements.

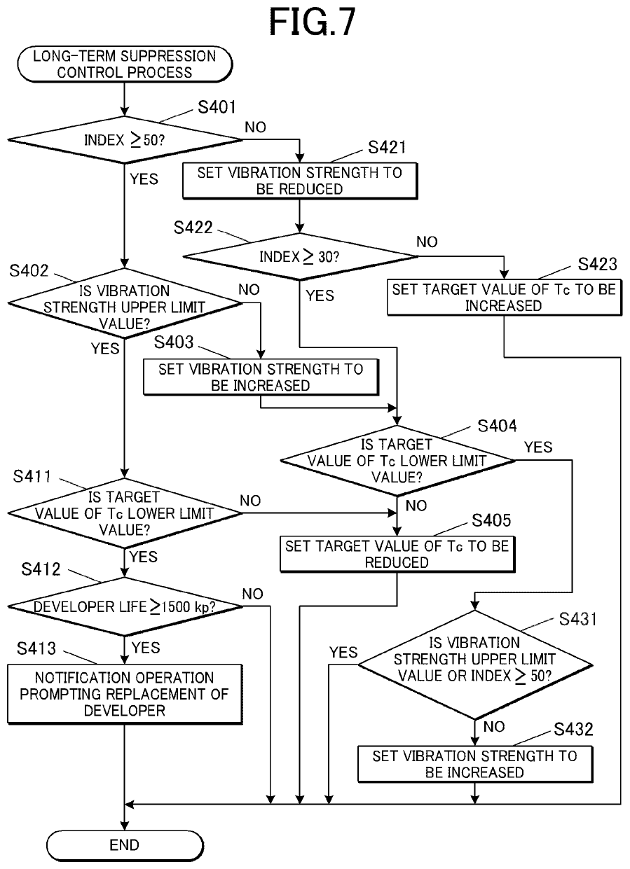

FIG. 7 is a flowchart showing the procedure of control by the hardware processor 10 in a long-term suppression control process performed according to the long-term prediction result relevant to the occurrence of a toner spill defect. This long-term suppression control process may be further performed subsequent to the short-term suppression control process when the result of the above defect occurrence prediction process is acquired.

Once the long-term suppression control process starts, the hardware processor 10 (CPU 11) determines whether or not the defect occurrence index is 50 or more (step S401). When it is determined that the defect occurrence index is 50 or more (“YES” in step S401), the hardware processor 10 determines whether or not the vibration strength of the vibrator 67 is set to the upper limit value. (step 402). When it is determined that the vibration strength of the vibrator 67 is not the upper limit value (“NO” in step S402), the hardware processor 10 sets the vibration strength to be increased by one step (step S403).

The hardware processor 10 determines whether or not the target value of the toner density Tc is the lower limit value (step S404). When it is determined that the target value of the toner density Tc is not the lower limit value (“NO” in step S404), the hardware processor 10 sets the target value of the toner density Tc to be reduced by one step (step S405). The target value of the toner density Tc is reduced by increasing the amount of charge. Then, the hardware processor 10 ends the long-term suppression control process.

When it is determined in the determination process of step S404 that the target value of the toner density Tc is already the lower limit value (“YES” in step S404), the hardware processor 10 determines whether or not the vibration strength is the upper limit value or whether or not the defect occurrence index is 50 or more (step S431). When it is determined that the vibration strength is the upper limit value or the defect occurrence index is 50 or more (“YES” in step S431), the hardware processor 10 ends the long-term suppression control process. When it is determined that the vibration strength is not the upper limit value and the defect occurrence index is not 50 or more (“NO” in step S431), the hardware processor 10 sets the vibration strength of the vibrator 67 to be increased by one step (step S432). Then, the hardware processor 10 ends the long-term suppression control process.

When it is determined in the determination process of step S402 that the vibration strength is the upper limit value (“YES” in step S402), the hardware processor 10 determines whether or not the target value of the toner density Tc is the lower limit value (step S411). When it is determined that the target value of the toner density Tc is not the lower limit value (“NO” in step S411), the process of the hardware processor 10 proceeds to step S405.

When it is determined that the target value of the toner density Tc is the lower limit value (“YES” in step S411), the hardware processor 10 determines whether or not the developer life is 1500 kp or more (step S412). When it is determined that the developer life is 1500 kp or more (“YES” in step S412), the hardware processor 10 performs a notification operation prompting the replacement of the developer. The notification operation may be performed, for example, by showing characters indicating the replacement of the developer, a warning identification number, a figure, or the like on the display 51. An LED lamp or the like may be lit or blinked in a color indicating a warning. Upon seeing the warning, the user (administrator) may check the inventory of the replacement developer and/or may arrange for the replacement developer, or may request a maintenance company, a service center, or the like to take action. Then, the hardware processor 10 ends the long-term suppression control process. When it is determined that the developer life is not 1500 kp or more (is less than 1500 kp) (“NO” in step S412), the hardware processor 10 ends the long-term suppression control process.

When it is determined in the determination process of step S401 that the defect occurrence index is not 50 or more (is less than 50) (“NO” in step S401), the hardware processor 10 sets the vibration strength of the vibrator 67 to be reduced by one step (step S421). When the vibration strength is already at the lowest level, the lowest vibration strength may be maintained as it is.

The hardware processor 10 determines whether or not the defect occurrence index is 30 or more (step S422). When it is determined that the defect occurrence index is 30 or more (“YES” in step S422), the process of the hardware processor 10 proceeds to step S404.

When it is determined that the defect occurrence index is not 30 or more (is less than 30) (“YES” in step S422), the hardware processor 10 sets the target value of the toner density Tc to be increased by one step (step S423). When the target value of the toner density Tc is already the maximum value, the hardware processor 10 may maintain the target value of the toner density Tc as it is. Then, the hardware processor 10 ends the long-term suppression control process.

Since the long-term suppression control process is not a process having an immediate effect, a countermeasure setting is made at a stage in which the defect occurrence index is lower than that in the short-term suppression control process, such as 30 or more. On the other hand, the short-term suppression control process is a process in a state in which a defect is unlikely to occur for a short time when the possibility of occurrence of a defect increases. Therefore, measures are made after the defect occurrence index reaches 50 or more, especially 80 or more. In this manner, by calculating two types of defect occurrence indices for a long period and a short period, it is possible to take appropriate measures according to the degree of urgency of defect occurrence.

In addition to the above, for example, a fog margin (difference between the bias voltage of the photoconductor drum and the developing voltage. Since the ease of adhesion of toner to the photoconductor drum changes according to the magnitude, this also affects the amount of toner consumed) can be mentioned as an operation parameter that affects toner spill. By changing the setting so that a large amount of toner is consumed to form an image not only in the refresh operation in the short-term suppression control process but also in the image forming operation, it is possible to reduce the residual of the deteriorated toner in the developer 63.

Both the short-term suppression control process and the long-term suppression control process described above realize the operation of a suppression controller of the present embodiment.

In the above, toner spill has been described as an example of defects. However, other defects may also be suppressed based on predictions and prediction results according to the corresponding status of use or operation parameters. For example, in the case of predicting and suppressing the occurrence of image flow, it is expected that the possibility of the occurrence will increase in the short term due to an increase in absolute humidity and paper types with a lot of paper dust. Since the lack of lubricant and the amount of ozone generated can have an effect, the magnitude of the discharge voltage, the period of use of the lubricant application mechanism, the contact angle of the brush to apply lubricant, and the like may be used as operation parameters to calculate the contribution coefficient.

In the prediction limited to the poor removal of toner particles by the cleaner 66, the temperature inside the housing of the formation operator 60, which affects the degree of curing of the blade member for cleaning, the coverage relevant to the amount of toner particles to be removed (partial coverage), and the like can be the corresponding input data. The contact angle of the application brush or the period of use of the lubricant application mechanism relevant to the lack of lubricant may also be used as an operation parameter in the calculation of the contribution coefficient.

As described above, the image forming apparatus 1 having the operation status detection system of the present embodiment includes the hardware processor 10. As a status acquirer, the hardware processor 10 acquires data relevant to the operation status at each timing of the image forming apparatus 1 to be monitored (particularly, the formation operator 60) in association with the timing information. As a status predictor, the hardware processor 10 predicts the future operation status according to the acquired operation status for each of a plurality of periods having different lengths from the present.

Since the operation status is predicted for a plurality of different periods in this manner, it is possible to properly make short-term measures and long-term preparations and measures according to the plurality of prediction contents. Therefore, based on the result of the prediction of the operation status, it is possible to take more effective measures according to the situation.

The image forming apparatus 1 includes the storage 20. As a first storage, the acquired data relevant to the operation status is stored in the status-of-use data 21 and the environment measurement data 22. By storing the data in this manner, it is possible to easily input time-series data or easily select necessary data.

The operation status includes the environmental state of the image forming apparatus 1. Since the temperature or humidity of each unit also affects the operation, these can also be included in the operation status of the prediction target to predict the future operation more reliably.

The hardware processor 10 has the prediction model 261, which is a machine learning model trained by using data relevant to the operation status as teacher data, as a status predictor. By predicting the operation using the prediction model 261 obtained from actual data, it is possible to flexibly and appropriately improve the prediction accuracy according to the operating environment or usage characteristics of each image forming apparatus 1.

As a second storage, the storage 20 stores, in the prediction data 23, the operation status predicted for each of a plurality of periods by the hardware processor 10 as a status predictor. As a comparer, the hardware processor 10 compares the predicted operation status with the actual operation status at each predetermined timing in the plurality of periods relevant to the predicted operation status. As an updater, the hardware processor 10 updates the prediction model 261 by further training the prediction model 261 based on the comparison result.

Thus, by comparing its own prediction result with the corresponding actual operation status and feeding the comparison result back to the prediction model 261, it is possible to flexibly respond to changes in the status of use of the image forming apparatus 1 and output appropriate prediction results.

As a generator, the hardware processor 10 generates the prediction model 261 using the data relevant to the operation status as teacher data. By making it possible to generate the prediction model 261 by its own machine in this manner, it is possible to predict the operation status by using the appropriate prediction model 261 according to the usage characteristics of each image forming apparatus 1 or the characteristics of the operating environment.

The predicted operation status includes information regarding the probability of occurrence of a predetermined operation status. By expressing this not only as a representative predicted value but also as a probability distribution, it is possible to take more flexible measures considering the range of prediction.

The image forming apparatus 1 having the defect occurrence prediction system of the present embodiment includes each of the components described above. As a third storage, the storage 20 stores, in the defect handling data 24, the first correspondence relationship between the operation status and the occurrence of a predetermined defect in the image forming apparatus 1. The hardware processor 10 includes a defect predictor that calculates a predetermined index relevant to the possibility of occurrence of a defect based on the predicted operation status and the first correspondence relationship.

Thus, since the occurrence of a defect is further predicted based on the obtained prediction result of the operation status, it is possible to obtain more accurate information regarding whether a problem is likely to occur soon depending on the status of use in the day or at the time or changes in the environment or the use can be continued to some extent.

As a fourth storage, the storage 20 stores, in the operation parameter contribution data 25, the second correspondence relationship (contribution coefficient) between the operation parameters of the image forming apparatus 1 and the degree of contribution of the operation parameter to the occurrence of a predetermined defect. As a setting acquirer, the hardware processor 10 acquires the operation parameter. As a defect predictor, the hardware processor 10 acquires the contribution coefficient based on the acquired operation parameters and the second correspondence relationship and corrects the defect occurrence index using the contribution coefficient. In this manner, by using the operation parameters supplementally for estimating the degree of occurrence of a defect, it is possible to further improve the prediction accuracy. Since these operation parameters are in-situ values rather than cumulative values, the prediction model 261 are not complicated more than necessary by separating the operation parameters from the prediction model 261 and evaluating these supplementally as the contribution to the defect occurrence index.

As a defect predictor, the hardware processor 10 calculates a defect occurrence index for each of a plurality of different periods. By performing defect prediction in a plurality of periods according to the operation status predictions in the plurality of periods, it is possible to flexibly respond to the situation, such as waiting for a short time until maintenance becomes possible while looking at the future schedule or performing an operation for a long period of time so as not to cause a problem in the current condition while adjusting the operation parameters as soon as possible.

The image forming apparatus 1 of the present embodiment includes the defect occurrence prediction system described above. Therefore, it is possible to predict the occurrence of defects, such as abnormalities in image quality in the image forming operation, in each of the long period and the short period. Especially for business use, it may be a problem if the image quality is abnormal, and it may be difficult to immediately stop using the image forming apparatus and perform maintenance. Therefore, by predicting the occurrence of a defect as described above, it is possible to take measures more flexibly and appropriately according to the schedule or the like.

The image forming apparatus 1 includes a suppression operator that performs a predetermined operation for suppressing the occurrence of a defect, such as the vibrator 67. As a suppression controller, the hardware processor 10 controls the operation of the suppression operator. As the suppression controller, the hardware processor 10 controls the operation of the suppression operator according to the operating conditions corresponding to each of the defect occurrence indices in a plurality of different periods. The suppression operator referred to herein is not limited to a dedicated configuration for suppressing the occurrence of a defect, and includes everything that can change the setting to a state in which the defect is easily suppressed for the normal operation setting. That is, in the image forming apparatus 1, it is possible to change the operation parameters and the like so that a reasonable operation can be performed based on the long-term and short-term defect occurrence predictions.

At least apart of the operation status is acquired based on the job data relevant to the image formation command. By directly using the job data including the operation setting or the image data relevant to the image to be formed, the prediction model 261 that appropriately grasps the characteristics of the status of use or the time-series change can be obtained, and the future status of use can be predicted by the prediction model 261.

The operation status prediction method of the present embodiment includes: a status acquisition step in which data relevant to the operation status of the operation device to be monitored at each timing is acquired so as to be associated with the timing information; and a status prediction step in which the future operation status is predicted according to the operation status acquired in the status acquisition step for each of a plurality of periods having different lengths from the present. By predicting the operation status for the plurality of periods as described above, it is possible to flexibly take short-term and long-term measures. Therefore, by efficiently setting the timing or time of maintenance, it is possible to easily avoid maintenance at unfavorable timings.

The invention is not limited to the above embodiment, and various modifications can be made.

For example, in the above embodiment, two types of defect occurrence indices for a short period and a long period are output, but three or more types, for example, midterm prediction or prediction longer than that for the above-described long period (two days to one month) may be further performed. Those output for the short period and the long period do not have to be the same index.

The defect occurrence index may be displayed on the display 51 or the like. In this case, how much the defect occurrence index decreases due to the setting change by the short-term suppression control process/long-term suppression control process may be displayed together with the defect occurrence index.

In the above embodiment, the machine learning model using a neural network and the ARIMA model have been described as examples of the prediction model, but the invention is not limited thereto. For example, algorithms such as perceptron and logistic regression may be used, or various other time-series models may be used. “Teacher data” in the learning of these models broadly means correct answer data in general.

The machine learning model does not need to be generated in the image forming apparatus 1, and may be generated by an external computer. The update learning process may also be performed externally, and only the updated parameters may be subsequently acquired by the image forming apparatus 1.

The prediction operation itself may not be performed in the image forming apparatus 1, and some or all of the measurement results of the measurer 70 may not be acquired and/or stored by the image forming apparatus 1. Using the measurement results of an external measurement device, a process relevant to prediction may be performed by an external computer or the like.

In the above embodiment, it has been described that the occurrence of a defect in image quality in the image forming apparatus 1 is predicted, but it may be possible to predict not only the image quality but also other troubles. The operation status of an operation device (particularly, a device that physically operates something) other than the image forming apparatus 1 may be predicted. In this case, the occurrence of various defects may be predicted according to the predicted operation status and the operation device.

The prediction of the operation status does not necessarily have to be used for the prediction of the occurrence of a defect. For example, this may be used for the operation control of an air conditioner in a room having an operation device or the adjustment of an attendance schedule of a user of the operation device.

The machine learning model does not necessarily have to be updated regularly. In learning that includes irregular data or abnormal data, the prediction accuracy may be lowered. Therefore, the machine learning model may be updated only when the learning data is generated by the separate analysis process.

In the embodiment described above, the operation parameters are used to calculate the contribution to the defect occurrence index calculated separately, but the operation parameters may also be directly used to calculate the defect occurrence index. The index indicating the possibility of occurrence of a defect does not have to be a numerical value, such as an index. The index indicating the possibility of occurrence of a defect may be a numerical value or may not be obtained by calculation. For example, the index indicating the possibility of occurrence of a defect may be obtained from a table shown in a matrix. The specific configuration, the content and procedure of the processing operation, and the like shown in the above-described embodiment can be appropriately changed without departing from the spirit of the invention. The scope of the invention includes the scope of the invention described in the claims and the equivalent scope thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An operation status prediction system, comprising:
a hardware processor,
wherein,
the hardware processor acquires data, which is relevant to an operation status at each timing of an operation device to be monitored, so as to be associated with information of the timing, and
the hardware processor predicts a future operation status according to the acquired operation status for each of a plurality of periods having different lengths from the present.

2. The operation status prediction system according to claim 1, further comprising, a first storage that stores the acquired data relevant to the operation status.

3. The operation status prediction system according to claim 1, wherein, the operation status includes an environmental state of the operation device.

4. The operation status prediction system according to claim 1, wherein, the hardware processor has a machine learning model trained using the data relevant to the operation status as teacher data.

5. The operation status prediction system according to claim 4, further comprising:
a second storage that stores the operation status predicted for each of the plurality of periods,
wherein,
the hardware processor compares the predicted operation status with an actual operation status at each predetermined timing in the plurality of periods relevant to the predicted operation status, and
the hardware processor updates the machine learning model based on a comparison result by further training the machine learning model.

6. The operation status prediction system according to claim 4, wherein, the hardware processor generates the machine learning model using the data relevant to the operation status as teacher data.

7. The operation status prediction system according to claim 1, wherein, the predicted operation status includes information regarding a probability of occurrence of a predetermined operation status.

8. A defect occurrence prediction system, comprising:
the operation status prediction system according to claim 1; and
a third storage that stores a first correspondence relationship between the operation status and occurrence of a predetermined defect in the operation device,
wherein, the hardware processor calculates a predetermined index relevant to a possibility of occurrence of the defect based on the predicted operation status and the first correspondence relationship.

9. The defect occurrence prediction system according to claim 8, further comprising:
a fourth storage that stores a second correspondence relationship between an operation setting of the operation device and a degree of contribution of the operation setting to occurrence of the predetermined defect,
wherein,
the hardware processor acquires the operation setting, and
the hardware processor acquires the degree of contribution based on the acquired operation setting and the second correspondence relationship, and corrects the predetermined index according to the degree of contribution.

10. The defect occurrence prediction system according to claim 8, wherein, the hardware processor calculates the predetermined index for each of the plurality of different periods.

11. An image forming system, comprising:
the defect occurrence prediction system according to claim 8.

12. The image forming system according to claim 11, further comprising:
a suppression operator that performs a predetermined operation for suppressing occurrence of a defect,
wherein,
the hardware processor controls an operation of the suppression operator, and
the hardware processor controls the operation of the suppression operator according to operating conditions corresponding to the predetermined index in each of the plurality of different periods.

13. The image forming system according to claim 11, wherein at least a part of the operation status is acquired based on job data relevant to an image formation command.

14. An operation status prediction method, comprising:
status acquiring in which data relevant to an operation status of an operation device to be monitored at each timing is acquired so as to be associated with information of the timing; and
status predicting in which a future operation status is predicted according to the operation status acquired in the status acquiring for each of a plurality of periods having different lengths from the present.
